(19) United States
(12) Patent Application Publication
(10) Pub. No.: US 2009/0093333 A1
(43) Pub. Date: Apr. 9, 2009

(54) AXLE ASSEMBLY WITH ELECTRO-HYDRAULIC CLUTCH CONTROL SYSTEM

(76) Inventors: Herbert L. Adams, III, Waterford, MI (US); Paul J. Valente, Berkley, MI (US); James P. Downs, South Lyon, MI (US)

Correspondence Address: HARNESS, DICKEY & PIERCE, P.L.C., P.O. BOX 828, BLOOMFIELD HILLS, MI, 48303, US

(21) Appl. No.: 11/868,717

(22) Filed: Oct. 8, 2007

(51) Int. Cl. F16H 48/30; B60K 17/35; G06F 7/00

(52) U.S. Cl. 475/88; 180/249; 701/38

(57) ABSTRACT

An axle assembly for a vehicle. The axle assembly includes an input shaft, a first and second output shaft, and a differential assembly. The axle assembly also includes a clutch assembly with an input member coupled to the differential assembly, an output member coupled to one of the first output shaft and the second output shaft, and a clutch member that selectively couples the input and output members. The axle assembly also includes a pump that supplies pressurized fluid to the clutch to control coupling of the input and output members. The axle assembly further includes a motor that drives the pump. The speed of the motor is controllable in order to change a fluid pressure supplied by the pump. The change in fluid pressure from the pump actuates the clutch member to thereby vary the torque between the first output shaft and the second output shaft.

### FIELD

The present disclosure relates to an axle assembly and, more specifically, relates to an axle assembly with an electro-hydraulic clutch control system.

### BACKGROUND

The statements in this section merely provide background information related to the present disclosure and may not constitute prior art.

In many vehicles, an engine delivers torque to an input shaft, and the input shaft delivers torque to a differential assembly, which delivers torque to individual output shafts to thereby drive the wheels respectively attached to the output shafts. However, in many differential assemblies (e.g., open differential assemblies), the amount of torque delivered to the wheels is limited to the greatest amount that will not make either wheel slip. Thus, if one wheel on the axle is on a low traction surface, such as ice, the torque delivered to both wheels is relatively low, and thus the vehicle may not be able to move.

In partial response to this problem, systems have been developed that at least partially lock the differential such that torque is more effectively delivered to both output shafts in a loss of traction situation. For instance, some axle assemblies include a hydraulic system and a clutch operatively connected to the differential assembly. The hydraulic system includes a plurality of valves that are controlled in order to change hydraulic pressure to thereby actuate the clutch. Thus, if one wheel experiences a loss of traction, the clutch actuates and at least partially locks the differential assembly such that the output shafts rotate at approximately the same speed. Thus, torque is more effectively delivered from the engine to the output shafts, and the handling of the vehicle improves.

However, this type of axle assembly suffers from certain disadvantages. For instance, the valves of the hydraulic system and the associated control system increase the number of parts of the axle assembly. Accordingly, manufacture and repair of the axle assembly can be fairly complicated and expensive. Furthermore, these prior art axle assemblies may not provide adequate response time due to the complicated hydraulic system.

### SUMMARY

An axle assembly is disclosed for a vehicle. The axle assembly includes an input shaft, a first output shaft, a second output shaft, and a differential assembly for delivering torque from the input shaft to the first output shaft and the second output shaft. The axle assembly additionally includes a clutch assembly with an input member coupled to the differential assembly, an output member coupled to one of the first output shaft and the second output shaft, and a clutch member that selectively couples the input member and the output member. The axle assembly also includes a pump that is configured to supply a pressurized fluid to the clutch to control coupling of the input and output members. Furthermore, the axle assembly includes a motor that drives the pump. The speed of the motor is selectively controllable to change a fluid pressure supplied by the pump. The change in fluid pressure from the pump actuates the clutch member to thereby vary the torque between the first output shaft and the second output shaft.

In another aspect, a vehicle is disclosed that includes an engine and an input shaft that receives torque from the engine. The vehicle also includes an axle that includes a first output shaft and a second output shaft and a differential assembly for delivering torque from the input shaft to the first output shaft and the second output shaft. The vehicle further includes at least one axle assembly. The axle assembly includes a clutch assembly with an input member coupled to the differential assembly, an output member coupled to one of the first output shaft and the second output shaft, and a clutch member that selectively couples the input member and the output member. The axle assembly also includes a pump that is configured to supply a pressurized fluid to the clutch to control coupling of the input and output members. Additionally, the axle assembly includes a motor that drives the pump. The speed of the motor is selectively controllable to change a fluid pressure supplied by the pump. The change in fluid pressure from the pump actuates the clutch member to thereby vary the torque between the first output shaft and the second output shaft.

In still another aspect, an axle assembly is disclosed for a vehicle. The axle assembly includes an input shaft, a first output shaft, a second output shaft, and an open differential assembly that includes a ring gear that is rotatably coupled to the input shaft and a case that is fixed to the ring gear. The open differential assembly delivers torque from the input shaft to the first output shaft and the second output shaft. The axle assembly also includes a controller and a clutch assembly that includes an input member coupled to the case, an output member coupled to one of the first output shaft and the second output shaft, and a clutch member that actuates so as to selectively couple the input member and the output member. The axle assembly also includes a pump that is configured to supply a pressurized fluid to the clutch to control coupling of the input and output members. Additionally, the axle assembly includes a motor that drives the pump. The controller controls the speed of the motor in order to change a fluid pressure supplied by the pump. The change in fluid pressure from the pump actuates the clutch member to thereby vary the torque between the first output shaft and the second output shaft. Furthermore, the pump supplies a full fluid pressure at which the clutch assembly locks the input member and the output member, and the pump also supplies a partial fluid pressure at which the clutch assembly partially couples the input member and the output member.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle with one embodiment of an axle assembly; and

FIG. 2 is a schematic detail view of the axle assembly of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

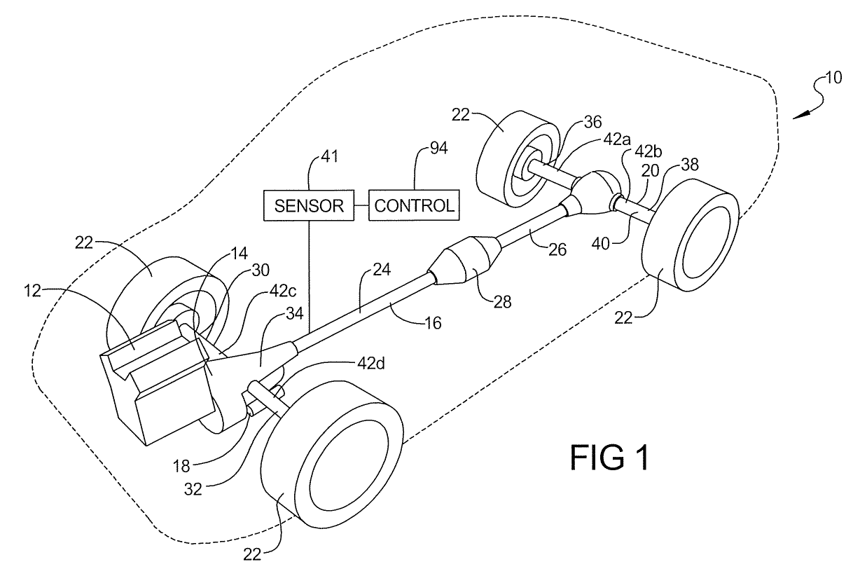

Referring initially to FIG. 1 a vehicle 10 is shown. The vehicle 10 includes an engine 12, a transmission 14, a drive shaft 16, a front axle 18, and a rear axle 20. The engine 12 delivers torque to the transmission 14, which delivers the torque to the drive shaft 16, and the torque is delivered to the front and rear axle 18, 20. As such, the front and rear axle 18, 20 rotate to thereby drivingly rotate the wheels 22 coupled to respective ends of either the front or rear axle 18, 20.

More specifically, the drive shaft 16 includes a front drive shaft 24, and a rear drive shaft 26, which are operatively coupled to each other via a center differential 28. The front drive shaft 24 is operatively coupled to the front axle 18 for delivering torque from the engine 12 to the front axle 18, and the rear drive shaft 26 is operatively coupled to the rear axle 20 for delivering torque from the engine 12 to the rear axle 20. The center differential 28 allows the front drive shaft 24 and the rear drive shaft 26 to rotate at different speeds.

Moreover, the front axle 18 includes a first front output shaft 30 and a second front output shaft 32, which are operatively coupled to each other via a front differential assembly 34. Likewise, the rear axle 20 includes a first rear output shaft 36 and a second rear output shaft 38, which are operatively coupled to each other via a rear differential assembly 40. The front differential assembly 34 delivers torque from the front drive shaft 16 to the first and second front output shafts 30, 32 and allows the first and second front output shafts 30, 32 to rotate at different speeds to facilitate turning, etc. Likewise, the rear differential assembly 40 delivers torque from the rear drive shaft 26 to the first and second rear output shafts 36, 38 and allows the first and second rear output shafts 36, 38 to rotate at different speeds to facilitate turning, etc.

The vehicle 10 also includes a sensor system, schematically shown at 41. In one embodiment, the sensor system 41 includes at least one of a torque sensor for detecting a torque of one of the output shaft 30, 32, 36 38, a speed sensor for detecting the speed of the vehicle 10, a steering wheel angle sensor for detecting the steering wheel angle for the vehicle 10, a cornering force sensor for detecting cornering force of the vehicle 10, and a yaw sensor for detecting a yaw amount of the vehicle 10.

In addition, the vehicle 10 includes at least one axle assembly 42a, 42b, 42c, 42d. In the embodiment shown, the vehicle 10 includes a first axle assembly 42a, a second axle assembly 42b, a third axle assembly 42c, and a fourth axle assembly 42d. The first axle assembly 42a is operatively coupled to the rear differential 40 and the first rear output shaft 36. The second axle assembly 42b is operatively coupled to the rear differential 40 and the second rear output shaft 38. The third axle assembly 42c is operatively coupled to the front differential 34 and the first front output shaft 30. Finally, the fourth axle assembly 42d is operatively coupled to the front differential 34 and the second front output shaft 32.

As will be described in greater detail below, the first and second axle assemblies 42a, 42b selectively change the distribution of power from the engine 12 between the first and second rear output shafts 36, 38, and the third and fourth axle assemblies 42c, 42d selectively change the distribution of power from the engine 12 between the first and second front output shafts 30, 32. As such, the first and second axle assemblies 42a, 42b vary the torque between the first and second rear output shaft 36, 38, and the third and fourth axle assemblies 42c, 42d vary the torque between the first and second front output shafts 30, 32. Thus, for instance, if the wheel 22 attached to the second rear output shaft 38 experiences a loss of traction, the first axle assembly 42a functions to couple the first rear output shaft 36 and the second rear output shaft 38 via the rear differential 40 such that power from the second rear output shaft 38 is redistributed to the first rear output shaft 36 (i.e., more power is delivered to the first rear output shaft 36 and torque of the first rear output shaft 36 exceeds the torque of the second rear output shaft 38). Accordingly, handling of the vehicle 10 is improved.

It will be appreciated that the vehicle 10 could be a rear wheel drive vehicle 10 or a front wheel drive vehicle 10 instead of the all wheel drive vehicle 10 shown in FIG. 1 without departing from the scope of the present disclosure. It will also be appreciated that the vehicle 10 can include any number of axle assemblies 42a, 42b, 42c, 42d without departing from the scope of the present disclosure. For instance, in one embodiment, the vehicle 10 is a rear wheel drive vehicle 10 (instead of the all wheel drive vehicle 10 shown in FIG. 1), and the vehicle 10 includes only the first and second axle assemblies 42a, 42b. It will also be appreciated that the vehicle 10 could include at least one axle assembly operatively coupled to the drive shaft 16 and the center differential 28 to vary torque between the front and rear drive shafts 24, 26, without departing from the scope of the present disclosure.

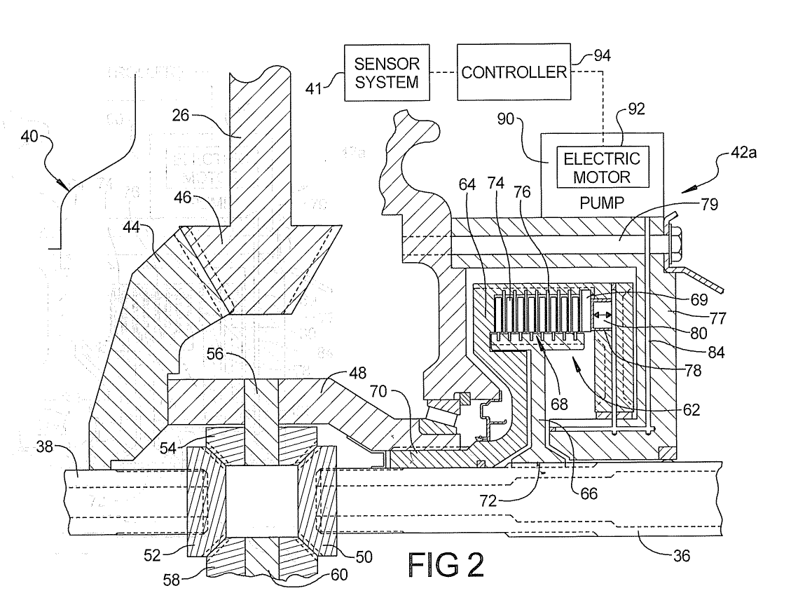

Referring now to FIG. 2 the rear drive shaft 26, the rear differential 40, and the first axle assembly 42a are shown in detail. It will be appreciated that the other axle assemblies 42b, 42c, 42d are substantially similar to the first axle assembly 42a shown in FIG. 2. Therefore, the redundant description of the second, third, and fourth axle assemblies 42b, 42c, 42d is omitted.

In the embodiment shown, the rear differential 40 is an open differential and includes ring gear 44 that is mounted for rotation about the axes of the first and second rear output shafts 36, 38. The ring gear 44 is a bevel gear that meshes with and is rotatably coupled to an input pinion 46. The input pinion 46 is fixed to the rear drive shaft 26. Thus, rotation of the rear drive shaft 26 and input pinion 46 causes rotation of the ring gear 44. Furthermore, the rear differential 40 includes a case 48 that is fixed to the ring gear 44 for rotation about the axes of the first and second rear output shafts 36, 38. Moreover, the rear differential 40 includes a first side gear 50, which is a bevel gear that is fixed to the first rear output shaft 36, and a second side gear 52, which is a bevel gear that is fixed to the second rear output shaft 38. In addition, the rear differential 40 includes a first pinion 54 that is rotatably coupled to the case 48 via a first cross shaft 56. The rear differential 40 also includes a second pinion 58 that is rotatably coupled to the case 48 via a second cross shaft 60. The second pinion 58 is coupled to the case 48 on a side opposite to the first pinion 54. As such, the first and second pinions 54, 58 travel with the case 48 as it rotates. Also, the first pinion 54 is rotatable relative to the case 48 about the axis of the first cross shaft 56, and the second pinion 58 is rotatable relative to the case 48 about the axis of the second cross shaft 60. The first and second pinions 54, 58 each mesh with the first and second side gears 50, 52.

Accordingly, assuming that the vehicle 10 is traveling in a relatively straight path, both wheels 22 attached to the first and second rear output shafts 36, 38 should rotate at approximately the same speed. Thus, rotation of the rear drive shaft 26 and input pinion 46 rotatably drives the ring gear 44, which also rotates the case 48, and neither the first pinion 54 nor the second pinion 58 rotate relative to the case 48. As such, each of the side gears 50, 52 are effectively locked to the case 48, and power distribution between the first and second rear output shafts 36, 38 is substantially even. However, when the vehicle 10 enters a turn, the first and second pinions 54, 58 begin to rotate relative to the case 48, such that the first and second side gears 50, 52 and the first and second rear output shafts 36, 38 are able to rotate at different speeds. Accordingly, turning of the vehicle 10 is facilitated, and more speed is distributed to one wheel 22 (i.e., to the wheel 22 that travels further in the turn).

As shown in FIG. 2, the axle assembly 42a includes a clutch assembly 62. The clutch assembly 62 includes an input member 64, an output member 66, and a clutch member 68. The input member 64 is coupled to the case 48 of the rear differential 40. In the embodiment shown, the input member 64 is fixed to the case 48 via a spline 70. Also, the output member 66 is coupled to the first rear output shaft 36. In the embodiment shown, the output member 66 is fixed to the first rear output shaft 36 via a spline 72

It will be appreciated that the clutch member 68 could be of any suitable type for selectively coupling and uncoupling the input member 64 and the output member 66. In the embodiment shown, the clutch member 68 of the clutch assembly 62 includes a plurality of friction plates 74 and a plurality of drive plates 76. The friction plates 74 are coupled to the output member 66 of the clutch assembly 62, and the drive plates 76 are coupled to the input member 64 of the clutch assembly 62. The friction plates 74 and the drive plates 76 are arranged in alternating pairs along the axis of the first rear output shaft 36. Also, a lubricating coolant fluid is provided in the clutch member 68 such that the friction plates 74 and drive plates 76 are disposed within the fluid.

The friction plates 74 are biased away from the drive plates 76 such that the friction plates 74 can rotate relative to the drive plates 76, and thus, the input member 64 can rotate relative to the output member 66. Also, the friction plates 74 are frictionally engageable with the drive plates 76 to thereby transfer force between the input member 64 and the output member 66 of the clutch assembly 62.

The axle assembly 42a also includes a mounting member 77. The mounting member 77 is fixed to the case 48 of the differential via fasteners 79 such as bolts. The mounting member 77 defines a pressure chamber 80 and a plurality of hydraulic lines 84 extending therein. The hydraulic lines 84 are in fluid communication with the pressure chamber 80 to allow hydraulic fluid to flow therebetween. A piston 78 is moveably disposed within a pressure chamber 80. Hydraulic pressure changes within the pressure chamber 80 cause the piston 78 to actuate within the pressure chamber 80 along the direction of the axis of the first rear output shaft 36. As will be explained, activation of the piston 78 causes the input member 64 and output member 66 to couple or decouple.

The clutch member 68 also includes a pressure plate 69 provided adjacent the piston 78. As the piston 78 actuates toward the pressure plate 69, the pressure plate 69 pushes the drive plates 76 toward the respective friction plates 74 such that the drive plates 76 frictionally engage with the respective friction plates 74 and force can be transferred between the drive plates 76 and friction plates 74. As such, force can be transferred between the case 48 and the first rear output shaft 36. Once the piston 78 actuates away from the pressure plate 69, the friction plates 74 and the drive plates 76 are biased away from each other to thereby allow relative rotation between the first rear output shaft 36 and the case 48.

In addition, the axle assembly 42a includes a pump 90 that is configured to supply a pressurized fluid to the clutch assembly 62 to control coupling of the input and output members 64, 66. In the embodiment shown, the pump 90 is a hydraulic pump that is fluidly coupled to the pressure chamber 80 via the hydraulic lines 84.

The axle assembly 42a further includes a motor 92 that drives the pump 90. In one embodiment, the motor 92 is an electric motor that is electrically connected to a power source, such as the battery (not shown) of the vehicle 10. As will be described below, a speed of the motor 92 is selectively controllable to change a fluid pressure supplied by the pump.

In one embodiment, the pump 90 supplies a predetermined full fluid pressure to the piston 78, and the pump 90 also supplies a plurality of partial fluid pressures to the piston 78. At the full fluid pressure, the friction plates 74 and drive plates 76 are fully coupled such that the input and output members 64, 66 are fully locked and such that there is substantially no slip between the input and output members 64, 66. At partial fluid pressure, the friction plates 74 and drive plates 76 are partially coupled such that force is transferred therebetween, but a predetermined amount of slip is allowed between the input and output members 64, 66 of the clutch assembly 62. In one embodiment, the partial fluid pressure supplied by the pump 90 is infinitely adjustable between the full fluid pressure and zero pump pressure. As such, the axle assembly 42a is highly adjustable for more precise control of vehicle dynamics.

The axle assembly 42a further includes a controller 94 that is in electrical communication with the motor 92 of the pump 90. The controller 94 transmits signals to change the voltage supplied to the motor 92 such that the output of the motor 92 changes and thus the fluid pressure supplied by the pump 90 changes. In one embodiment, the controller 94 is a manual controller that includes a user-activated switch that allows the user to manually control the pump 90. In this embodiment, the user-activated switch is located on the dashboard of the vehicle 10 to allow the user to remotely control the axle assembly 42a from within the vehicle. In another embodiment, the controller 94 is an automatic controller that includes logic, etc. for automatically controlling the pump 90 based on driving conditions, etc.

The controller 94 is also in communication with the sensor system 41. The torque sensor, speed sensor, steering angle sensor, cornering force sensor, yaw sensor, and/or other sensor of the sensor system 41 detect the driving condition of the vehicle 10, the sensor system 41 transmits correlative data to the controller 94. The controller 94 controls and regulates the motor output (e.g., the voltage) to the motor 92 to thereby control and regulate the pump 90. Thus, the axle assembly 42a is controlled automatically.

More specifically, under normal driving conditions, the drive plates 76 and friction plates 74 of the clutch member 68 are biased away from each other such that the first rear output shaft 36 and the case 48 can rotate relative to each other. As such, the first rear output shaft 36 and the second rear output shaft 38 can rotate at different speeds as well.

However, under certain driving conditions detected by the sensor system 41, the controller 94 changes the voltage supplied to the motor 92 in order to increase the fluid pressure supplied by the pump 90 (i.e., the pump output). As such, the piston 78 actuates and causes the friction plates 74 and drive plates 76 to frictionally engage, and as such, the clutch assembly couples the case 48 of the rear differential 40 to the first rear output shaft 36. As a result, a portion of the power delivered from the vehicle engine 12 to the second rear output shaft 38 is redistributed to the first rear output shaft 36. Furthermore, torque in the first rear output shaft 36 exceeds the torque of the second rear output shaft 38.

Specifically, in a situation in which the wheel 22 of the second rear output shaft 38 loses traction, the sensor system 41 detects the loss of traction. The sensor system 41 thus transmits a correlative signal to the controller 94, which consequently increases the voltage supplied to the motor 92 and causes the pump 90 to increase fluid pressure. As a result, the piston 78 actuates and causes the clutch member 68 to couple the case 48 to the first rear output shaft 36. As such, power is redistributed from the slipping wheel 22 on the second rear output shaft 38 to the opposite wheel 22 attached to the first rear output shaft 36. Also, torque in the first rear output shaft 36 becomes greater than the torque in the second rear output shaft 38. Thus, more power and torque is delivered to the wheel 22 that has adequate traction, and the vehicle 10 drivability is improved. It will be appreciated that each of the axle assemblies 42a, 42b, 42c, 42d are controlled in this manner such that power from the engine 12 is distributed to each wheel 22 more precisely depending on the driving conditions.

Furthermore, in some driving conditions, the pump 90 supplies a full fluid pressure to the clutch assembly 62 to effectively lock the output shafts 36, 38 of the axle 20. In other driving conditions, the pump 90 supplies a partial fluid pressure to the clutch assembly 62 such that power is redistributed between the output shafts 36, 38 and also such that a predetermined amount of slip is allowed between the output shafts 36, 38. Accordingly, torque to the output shafts 36, 38 can be infinitely adjusted, and drivability of the vehicle 10 is improved.

For instance, if the sensor system 41 detects a severe turn (e.g., via the steering angle sensor, etc.) the controller 94 causes the pump 90 to supply a predetermined fluid pressure to the clutch assembly 62. However, if the sensor system 41 detects a less severe turn, the control 94 causes the pump 90 to supply a higher fluid pressure to the clutch assembly 62. Accordingly, drivability of the vehicle 10 is improved.

Moreover, in one embodiment, the sensor system 41 communicates with the control 94 in a closed-loop feedback system. For instance, the torque sensor of the sensor system 41 detects the torque in the output shaft 36 and repeatedly sends correlative signals to the controller 94, and the controller 94 controls the fluid pressure from the pump 90 until the intended amount of torque is detected in the output shaft 36.

In another embodiment in which the controller 94 is a manual controller with a user-activated switch, the switch is manually activated to control and regulate the motor output from the motor 92 to thereby control and regulate the pump 90. For instance, when the vehicle 10 is being driven on a low-traction surface (e.g., on an icy road, etc.), the user manually activates the controller 94 to increase voltage to the motor 92 such that the pump 90 increases fluid pressure output, and the clutch assembly 62 couples first rear output shaft 36 with the case 48 of the rear differential 40. Thus, the user has selective control over the axle assembly 42a. It will be appreciated that the manual controller communicates with each of the axle assemblies 42a, 42b, 42c, 42d in a similar manner.

Moreover, it is understood that the front differential assembly 34 and the rear differential assembly 20 have an associated reduction ratio due to the gear ratio between the respective ring gear 44 and input pinion 46, etc. For a vehicle 10 that includes the first and second axle assemblies 42a, 42b for the rear axle 20 and the third and fourth axle assemblies 42c, 42d for the front axle 18, the reduction ratio of the rear differential assembly 20 is less than the reduction ratio of the front differential assembly 34. In one embodiment, for instance, the reduction ratio of the rear differential assembly 20 is 2% to 5% less than the reduction ratio of the front differential assembly 34.

In summary, the axle assembly 42a-42d can be installed in the vehicle 10 to improve vehicle dynamics. In one embodiment, the axle assembly 42a-42d is included in a torque vectoring system. To these ends, the axle assembly 42a-42d can be operatively coupled to the front differential assembly 34, the rear differential assembly 40, and/or the center differential 28.

It will be appreciated that the axle assembly 42a-42d described herein is a relatively simple design with a reduced number of components. Also, the control logic needed for controlling the axle assembly 42a-42d is relatively simple. Accordingly, the manufacturing, installation, repair, and programming of the axle assembly 42a is relatively simple and inexpensive. In addition, the axle assembly 42a-42d has a relatively fast response time for improved drivability. Furthermore, the axle assemblies 42a-42d are generally lightweight for greater fuel efficiency of the vehicle 10.

The disclosure has been described in an illustrative manner. It is to be understood that the terminology which has been used is intended to be in the nature of words of description rather than of limitation. Many modifications and variations are possible in light of the above teachings. Therefore, within the scope of the appended claims, the disclosure may be practiced other than as specifically described.

What is claimed is:

1. An axle assembly for a vehicle comprising:
an input shaft;
a first output shaft;
a second output shaft;
a differential assembly for delivering torque from the input shaft to the first output shaft and the second output shaft;
a clutch assembly that includes an input member coupled to the differential assembly, an output member coupled to one of the first output shaft and the second output shaft, and a clutch member that selectively couples the input member and the output member;
a pump that is configured to supply a pressurized fluid to the clutch assembly to control selective coupling of the input and output members; and
a motor that drives the pump, wherein a speed of the motor is selectively controllable to change a fluid pressure supplied by the pump, and wherein the change in fluid pressure from the pump actuates the clutch member to thereby vary the torque between the first output shaft and the second output shaft.

2. The axle assembly as claimed in claim 1, wherein the pump supplies a full fluid pressure at which the clutch assembly locks the input member and the output member such that there is substantially no slip therebetween, and wherein the pump also supplies a partial fluid pressure at which the clutch assembly partially couples the input member and the output member such that there is a predetermined amount of slip therebetween.

3. The axle assembly as claimed in claim 1, wherein the clutch member of the clutch assembly includes a plurality of friction plates and a plurality of drive plates, wherein the friction plates and the drive plates are arranged in alternating pairs, wherein the friction plates are biased away from the drive plates to allow the input member and the output member to rotate relative to each other, and wherein the friction plates are frictionally engageable with the drive plates to thereby couple the input member and the output member.

4. The axle assembly as claimed in claim 1, further comprising a controller for controlling the motor of the pump.

5. The axle assembly as claimed in claim 4, wherein the controller is a manual controller.

6. The axle assembly as claimed in claim 4, further comprising at least one of a torque sensor for detecting a torque of the one of the first output shaft and the second output shaft, a speed sensor for detecting a speed of the vehicle, a steering wheel angle sensor for detecting a steering wheel angle of the vehicle, a cornering force sensor for detecting a cornering force of the vehicle, and a yaw sensor for detecting a yaw amount of the vehicle, and wherein the controller automatically controls the motor depending on detected output from at least one of the torque sensor, the speed sensor, the steering wheel angle sensor, the cornering force sensor, and the yaw sensor.

7. The axle assembly as claimed in claim 1, wherein the differential assembly is an open differential assembly that includes a ring gear that is rotatably coupled to the input shaft and a case that is fixed to the ring gear, wherein the input member of the clutch assembly is coupled to the case.

8. The axle assembly as claimed in claim 1, wherein the motor is an electric motor, and wherein a voltage delivered to the motor is changed in order to change the fluid pressure supplied by the pump.

9. The axle assembly as claimed in claim 1, further comprising a piston that actuates due to fluid pressure supplied by the pump to thereby actuate the clutch assembly, wherein actuation of the clutch assembly selectively couples the input member and the output member.

10. A vehicle comprising:
an engine;
an input shaft that receives torque from the engine;
an axle that includes a first output shaft and a second output shaft;
a differential assembly for delivering torque from the input shaft to the first output shaft and the second output shaft; and
at least one axle assembly that comprises:
a clutch assembly that includes an input member coupled to the differential assembly, an output member coupled to one of the first output shaft and the second output shaft, and a clutch member that selectively couples the input member and the output member;
a pump that is configured to supply a pressurized fluid to the clutch assembly to control coupling of the input and output members; and
a motor that drives the pump, wherein a speed of the motor is selectively controllable to change a fluid pressure supplied by the pump, and wherein the change in fluid pressure from the pump actuates the clutch member to thereby vary the torque between the first output shaft and the second output shaft.

11. The vehicle as claimed in claim 10, wherein the pump supplies a full fluid pressure at which the clutch assembly locks the input member and the output member such that there is substantially no slip therebetween, and wherein the pump also supplies a partial fluid pressure at which the clutch assembly partially couples the input member and the output member such that there is a predetermined amount of slip therebetween.

12. The vehicle as claimed in claim 10, wherein the clutch member of the clutch assembly includes a plurality of friction plates and a plurality of drive plates, wherein the friction plates and the drive plates are arranged in alternating pairs, wherein the friction plates are biased away from the drive plates to allow the input member and the output member to rotate relative to each other, and wherein the friction plates are frictionally engageable with the drive plates to thereby couple the input member and the output member.

13. The vehicle as claimed in claim 10, further comprising a controller for controlling the motor of the pump.

14. The vehicle as claimed in claim 13, wherein the controller is a manual controller.

15. The vehicle as claimed in claim 13, further comprising at least one of a torque sensor for detecting a torque of the one of the first output shaft and the second output shaft, a speed sensor for detecting a speed of the vehicle, a steering wheel angle sensor for detecting a steering wheel angle of the vehicle, a cornering force sensor for detecting a cornering force of the vehicle, and a yaw sensor for detecting a yaw amount of the vehicle, and wherein the controller automatically controls the motor depending on detected output from at least one of the torque sensor, the speed sensor, the steering wheel angle sensor, the cornering force sensor, and the yaw sensor.

16. The vehicle as claimed in claim 10, wherein the differential assembly is an open differential assembly that includes a ring gear that is rotatably coupled to the input shaft and a case that is fixed to the ring gear, wherein the input member of the clutch assembly is coupled to the case.

17. The vehicle as claimed in claim 10, wherein the motor is an electric motor, and wherein a voltage delivered to the motor is changed in order to change the fluid pressure supplied by the pump.

18. The vehicle as claimed in claim 10, wherein the axle is one of a front axle having a front axle reduction ratio and a rear axle having a rear axle reduction ratio, wherein the rear axle reduction ratio is less than a front axle reduction ratio.

19. The vehicle as claimed in claim 18, wherein the rear axle reduction ratio is approximately 2% to 5% less than the front axle reduction ratio.

20. An axle assembly for a vehicle comprising:
an input shaft;
a first output shaft;
a second output shaft;
an open differential assembly that includes a ring gear that is rotatably coupled to the input shaft and a case that is fixed to the ring gear, wherein the open differential assembly delivers torque from the input shaft to the first output shaft and the second output shaft;
a controller;
a clutch assembly that includes an input member coupled to the case, an output member coupled to one of the first output shaft and the second output shaft, and a clutch member that actuates so as to selectively couple the input member and the output member;
a pump that is configured to supply a pressurized fluid to the clutch to control coupling of the input and output members; and
a motor that drives the pump, wherein the controller selectively controls a speed of the motor to change a fluid pressure supplied by the pump, wherein the change in fluid pressure from the pump actuates the clutch member to thereby vary the torque between the first output shaft and the second output shaft, wherein the pump supplies a full fluid pressure at which the clutch assembly locks the input member and the output member such that there is substantially no slip therebetween, and wherein the pump also supplies a partial fluid pressure at which the clutch assembly partially couples the input member and the output member such that there is a predetermined amount of slip therebetween.
